(19) United States
(12) Patent Application Publication
(10) Pub. No.: US 2014/0334094 A1
(43) Pub. Date: Nov. 13, 2014

(54) Heat-Dissipation Structure and Electronic Apparatus Using the Same

(71) Applicant: Acer Inc., New Taipei City (TW)

(72) Inventor: Kai-Hung Huang, New Taipei City (TW)

(73) Assignee: Acer Inc., New Taipei City (TW)

(21) Appl. No.: 14/254,941

(22) Filed: Apr. 17, 2014

(30) Foreign Application Priority Data
May 9, 2013 (TW) 102116566

(51) Int. Cl. G06F 1/20

(52) U.S. Cl. CPC G06F 1/20
USPC 361/679.47; 165/104.21

(57) ABSTRACT

A heat-dissipation structure is disclosed. The heat-dissipation structure is used on an electronic apparatus including a heating element and a vent structure. The heat-dissipation structure includes a heat pipe, a fin group, a fan, a heat-dissipation gate and a shape memory element. One end of the shape memory element is connected with the heat pipe and another end is connected with the heat-dissipation gate. Heat deformation of the shape memory element causes the heat-dissipation gate to move so as to open or close the vent structure.

### BACKGROUND OF THE INVENTION

1. Field of the Invention

The present invention relates to a heat-dissipation structure and an electronic apparatus using the heat-dissipation structure; more particularly, the present invention relates to a heat-dissipation structure and an electronic apparatus using the heat-dissipation structure wherein the size of a heat-dissipation hole can be adjusted according to different requirements.

2. Description of the Related Art

Generally, in order to make sure internal components such as a central processing unit (CPU) or a display card of an electronic apparatus will not be influenced by an operating temperature, fans and heat-dissipation holes are arranged so as to achieve a heat-dissipation effect. The function of a heat-dissipation hole is to let cool air flow into and out of the electronic apparatus and thereby to carry the heat away from the electronic apparatus by letting the air flow through heat-dissipation fins. In the past, when the laptop computer was comparatively thicker, the heat-dissipation hole was mostly arranged on the bottom or a side face to make the heat-dissipation hole invisible during use. However, with the popularity of mobile devices such as mobile phones and tablet computers, electronic apparatuses tend to be compact and thin, and thus it becomes more and more difficult to design the heat-dissipation hole. The overall appearance of the apparatus will be affected if the heat-dissipation hole is large, and the heat-dissipation effect will be insufficient if the heat-dissipation hole is too small.

Furthermore, during the process of designing the size of the heat-dissipation hole, the basic principle is to transfer out the heat generated when the electronic apparatus is working at its maximum power. However, under most conditions, such as when the apparatus is only used for Internet surfing or listening to music, the electronic apparatus does not generate too much heat. Because the heat-dissipation hole still performs heat dissipation at its normal size, it is easy for dust to be carried from the working environment into the apparatus, which could cause malfunction of the internal components and even reduce the life of the electronic apparatus.

Therefore, there is a need to provide a heat-dissipation structure and electronic apparatus using the same wherein the size of a heat-dissipation hole can be adjusted according to different requirements to mitigate and/or obviate the aforementioned problems.

### SUMMARY OF THE INVENTION

It is an object of the present invention to provide a heat-dissipation structure, wherein the size of its heat-dissipation hole can be adjusted according to different requirements.

It is another object of the present invention to provide an electronic apparatus, wherein the size of its heat-dissipation hole can be adjusted according to different requirements.

To achieve the abovementioned objects, according to one embodiment of the present invention, the heat-dissipation structure of the present invention is used in an electronic apparatus. The electronic apparatus includes a heating element and a vent structure. The heat-dissipation structure comprises a heat pipe, a fin group, a fan, a heat-dissipation gate and a shape memory element. The heat pipe is connected with the heating element and is used for guiding out heat energy generated by the heating element. The fin group is connected with the heat pipe. The fan is connected with the fin group and is used for generating an airflow passing through the fin group so as to transfer out the heat energy. The shape memory element has one end connected with the heat pipe and another end connected with the heat-dissipation gate. The shape memory element is used for receiving the heat energy to generate deformation so as to move the heat-dissipation gate to open or close the vent structure.

According to another embodiment of the present invention, the electronic apparatus of the present invention comprises a heating element, a vent structure and a heat-dissipation structure. The heat-dissipation structure comprises a heat pipe, a fin group, a fan, a heat-dissipation gate and a shape memory element. The heat pipe is connected with the heating element and is used for guiding out heat energy generated by the heating element. The fin group is connected with the heat pipe. The fan is connected with the fin group and is used for generating an airflow passing through the fin group so as to transfer out the heat energy. The shape memory element has one end connected with the heat pipe and another end connected with the heat-dissipation gate. The shape memory element is used for receiving the heat energy to generate deformation so as to move the heat-dissipation gate to open or close the vent structure.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a schematic drawing of an electronic apparatus with its vent closed according to one embodiment of the present invention.

FIG. 2 illustrates a schematic drawing of the electronic apparatus with its vent open according to one embodiment of the present invention.

### DETAILED DESCRIPTION OF THE PREFERRED EMBODIMENT

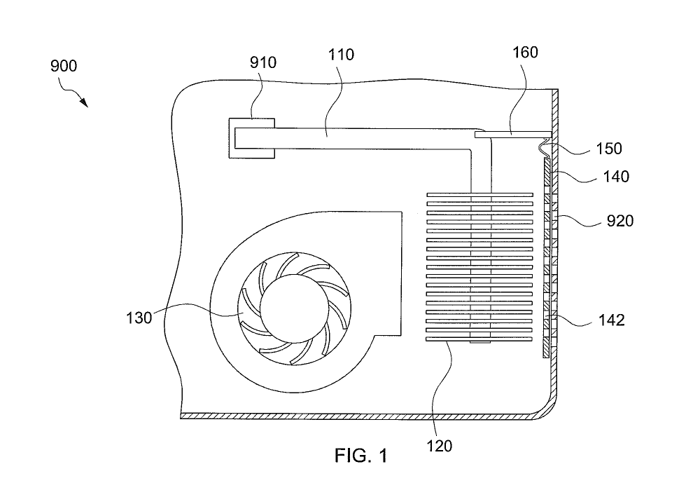

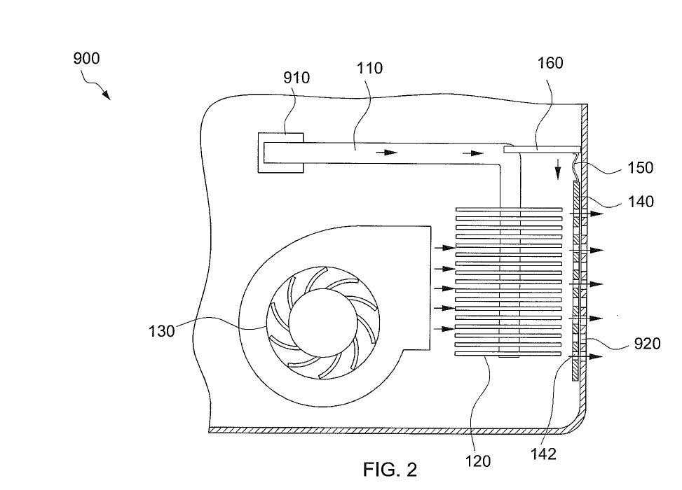

Please refer to FIG. 1 and FIG. 2, which illustrate an electronic apparatus according to one embodiment of the present invention. As shown in FIG. 1 and FIG. 2, according to one embodiment of the present invention, an electronic apparatus 900 comprises a heating element 910, a vent structure 920 and a heat-dissipation structure. The heat-dissipation structure comprises a heat pipe 110, a fin group 120, a fan 130, a heat-conductive sheet 160, a heat-dissipation gate 140 and a shape memory element 150.

According to one embodiment of the present invention, the electronic apparatus 900 can be, for example, a laptop computer; however, the electronic apparatus 900 is not limited to the laptop computer and can be any device with a similar structure. The heating element 910 is an electronic component that generates heat, such as a central processing unit (CPU), a graphics card or a north-bridge chip. The function of the heat-dissipation structure is to dissipate the heat energy generated by the heating element 910 so as to prevent the heating element 910 from being damaged due to overheating. According to one embodiment of the present invention, the vent structure 920 is in the form of a grating that includes a plurality of vents such that air can flow in or out through the vents so as to transfer out the heat energy generated by the heating element 910.

As shown in FIG. 1 and FIG. 2, according to one embodiment of the present invention, the heat pipe 110 is connected with the heating element 910 and is used for guiding out the heat energy generated by the heating element 910. The heat-dissipation structure further comprises a fan 130 and a fin group 120, wherein the fin group 120 is connected with part of the heat pipe 110. The fan 130 is connected with the fin group 120 and is used for generating an airflow that passes through the fin group 120 so as to carry the heat energy to the vent structure 920.

As shown in FIG. 1 and FIG. 2, according to one embodiment of the present invention, the heat-dissipation structure further comprises a heat-dissipation gate, a heat-conductive sheet 160 and a shape memory element 150. The heat-dissipation gate 140 is installed between the fin group 120 and the vent structure 920. The shape memory element 150 has one end connected with the heat pipe 110 via the heat-conductive sheet 160 and another end connected with the heat-dissipation gate 140. When the shape memory element 150 is heated by receiving the heat energy transferred from the heat pipe 110 and the heat-conductive sheet 160 and thereby generates deformation, the shape memory element 150 will move the heat-dissipation gate 140 to open or close the vent structure 920 accordingly. Please note that, according to another embodiment of the present invention, the heat-conductive sheet 160 can be ignored and thus the shape memory element 150 can be directly connected with the heat pipe 110.

According to one embodiment of the present invention, the material of the heat-conductive sheet 160 is a copper alloy or an aluminum alloy having good heat transmission efficiency. According to one embodiment of the present invention, the material of the shape memory element 150 is nickel titanium alloy, preferably with roughly equal proportions of nickel and titanium and a phase transition temperature of around 50 degrees; however, please note that the scope of the present invention is not limited to the above description.

According to one embodiment of the present invention, the heat-dissipation gate 140 comprises an opening structure 142. As shown in FIG. 1, if the shape memory element 150 is not heated, the opening structure 142 of the heat-dissipation gate 140 is staggered with the vent structure 920; therefore, the vent structure 920 is covered and the size of the heat-dissipation holes is reduced, providing a dustproof effect. As shown in FIG. 2, when the electronic apparatus 900 is operating at a high-loading power, the shape memory element 150 will be heated to generate deformation so as to move the heat-dissipation gate 140 such that the opening structure 142 overlaps with the vent structure 920 to open the vent structure 920. At this time, the airflow can flow in or out through the vent structure 920 so as to transfer out the heat energy generated by the internal heating element 910. When the electronic apparatus 900 is operating at a low-loading power, less heat will be generated, and therefore the shape memory element 150 will be deformed again and move the heat-dissipation gate 140 accordingly such that the opening structure 142 of the heat-dissipation gate 140 will be staggered with the vent structure 920 again so as to reduce the size of the heat-dissipation holes.

Although the present invention has been explained in relation to its preferred embodiments, it is to be understood that many other possible modifications and variations can be made without departing from the spirit and scope of the invention as hereinafter claimed.

What is claimed is:

1. A heat-dissipation structure, used in an electronic apparatus, the electronic apparatus including a heating element and a vent structure, the heat-dissipation structure comprising:
a heat pipe, connected with the heating element, used for guiding out heat energy generated by the heating element;
a fin group, connected with the heat pipe;
a fan, connected with the fin group, used for generating an airflow passing through the fin group so as to transfer out the heat energy;
a heat-dissipation gate; and
a shape memory element, wherein one end of the shape memory element is connected with the heat pipe and another end of the shape memory element is connected with the heat-dissipation gate, and the shape memory element is used for receiving the heat energy to generate deformation so as to move the heat-dissipation gate to open or close the vent structure.

2. The heat-dissipation structure as claimed in claim 1, further comprising:
a heat-conductive sheet, connected with the heat pipe and the shape memory element, used for transferring the heat energy to the shape memory element.

3. The heat-dissipation structure as claimed in claim 2, wherein the material of the heat-conductive sheet is copper alloy or aluminum alloy.

4. The heat-dissipation structure as claimed in claim 1, wherein the material of the shape memory element is nickel titanium alloy.

5. The heat-dissipation structure as claimed in claim 1, wherein the heat-dissipation gate comprises an opening structure such that according to the operation of the shape memory element that causes the heat-dissipation gate to move, the opening structure overlaps with the vent structure so as to open the vent structure.

6. An electronic apparatus, comprising:
a heating element;
a vent structure; and
a heat-dissipation structure, comprising:
a heat pipe, connected with the heating element, used for guiding out heat energy generated by the heating element;
a fin group, connected with the heat pipe;
a fan, connected with the fin group, used for generating an airflow passing through the fin group so as to transfer out the heat energy;
a heat-dissipation gate; and
a shape memory element, wherein one end of the shape memory element is connected with the heat pipe and another end of the shape memory element is connected with the heat-dissipation gate, and the shape memory element is used for receiving the heat energy to generate deformation so as to move the heat-dissipation gate to open or close the vent structure.

7. The electronic apparatus as claimed in claim 6, wherein the heat-dissipation structure further comprises:
a heat-conductive sheet, connected with the heat pipe and the shape memory element, used for transferring the heat energy to the shape memory element.

8. The electronic apparatus as claimed in claim 7, wherein the material of the heat-conductive sheet is selected from copper alloy and aluminum alloy.

9. The electronic apparatus as claimed in claim 6, wherein the material of the shape memory element is nickel titanium alloy.

10. The electronic apparatus as claimed in claim 6, wherein the heat-dissipation gate comprises an opening structure such that according to the operation of the shape memory element that causes the heat-dissipation gate to move, the opening structure overlaps with the vent structure so as to open the vent structure.
